(19) United States
(12) Patent Application Publication
(10) Pub. No.: US 2014/0183300 A1
(43) Pub. Date: Jul. 3, 2014

(54) TETHERED PAYLOAD SYSTEM AND METHOD

(71) Applicants: David MacCulloch, Wakefield, MA (US); Thomas Giorgi, New York, NY (US); Gregory S. Cote, Groton, MA (US)

(72) Inventors: David MacCulloch, Wakefield, MA (US); Thomas Giorgi, New York, NY (US); Gregory S. Cote, Groton, MA (US)

(73) Assignee: L-3 Communications Corporation, New York, NY (US)

(21) Appl. No.: 14/005,706

(22) PCT Filed: Jul. 20, 2012
(86) PCT No.: PCT/US12/47744

§ 371 Date: Sep. 17, 2013

Related U.S. Application Data
(60) Provisional application No. 61/509,718, filed on Jul. 20, 2011.
(60) Provisional application No. 61/641,279, filed on May 1, 2012.

(51) Int. Cl. B64C 39/02

(52) U.S. Cl. CPC B64C 39/022
USPC 244/1 TD

(57) ABSTRACT

A vehicle, especially a maritime vessel, is provided with an autogyro drawn by a tether. The tether contains mechanical strengthening components that enable it to securely retain the autogyro to the vehicle. The tether also contains two electrical conductors carrying different phases of AC power to the autogyro, and four optical fibers carrying optical data signals to and from the autogyro electronic payloads and avionics control circuitry. Signal converters at ends of the tether convert a wide range of electrical or wireless signals to optical data signals for transmission along the tether, and then back into the original electrical signal format for use by the autogyro or vehicle electronics.

### RELATED APPLICATIONS

This application claims the benefit of U.S. provisional application Ser. No. 61/641,279 filed on May 1, 2012, and of U.S. provisional application Ser. No. 61/509,718 filed on Jul. 20, 2011.

### FIELD OF THE INVENTION

This invention relates to systems and methods of electronic communications or surveillance, and more particularly, such systems with or methods employing an elevated antenna and electronic subsystems supported on an airborne platform drawn behind a moving land vehicle or sea-going vessel.

### BACKGROUND OF THE INVENTION

A number of governmental defense or law enforcement agencies require real-time intelligence in order to successfully execute their respective missions to protect national security and related interests.

There is a multitude of electronic intelligence, surveillance and reconnaissance (collectively “ISR”) capabilities available to military and law enforcement that are limited in practice because the radio or other electromagnetic signals generally require a line-of-sight for operation, and geographic constraints, including the terrain with e.g., intervening mountains, within which they must perform, limit the range of their operation.

In addition to ISR capabilities, other military and law enforcement technologies are restricted by “height of eye” considerations that define the distance to the horizon, and limit the distance of the operation due to the curvature of the earth. These technologies include radio frequency jamming, electronic attack, computer network operations and exploitation, laser targeting, and weapon countermeasure systems.

These tasks are further complicated by the need for clandestine operations in an environment of challenging terrain, range, limited manpower, and other operational and environmental concerns, that make solving the problem by a direct approach, such as by building a sensor or broadcast tower high enough to operate above the obstructing terrain or to extend the height of eye and the horizon, prohibitive in cost or impossible.

Historically, tethered balloons were used to extend the line of sight in military situations. In the surveillance context, balloons are undesirable, because they require a large footprint on the deck of a vessel, or a large ground area and a substantial number of personnel are required to act as ground crew. Furthermore, balloons are very large, and therefore visible, making surveillance less stealthy.

Another issue that also may arise with respect to prior art systems is that use of wires to communicate electronically with the aerial vehicle may present a concern for stealth or electronic warfare operation, in that it may be possible to intercept, interfere with or spoof the communication between the land vehicle and the aerial vehicle.

These and other constraints imposed by systems operating with a limited “height of eye” or line of sight can render the execution of military, homeland security and law enforcement missions more difficult.

### SUMMARY OF THE INVENTION

It is accordingly an object of the invention to provide a system and a method of electromagnetic-based and electro-optic interaction that overcomes the issues of height of eye or other obstruction such as curvature of the earth or terrain.

It is further an object of the invention that a tethered payload system of the invention overcomes the deficiencies of prior art and provides an enduring and clandestine method of real-time data intelligence/surveillance in threat environments that have limited visual range.

It is further an object of the invention to provide an airborne platform with one or more sensors, countermeasures, communications, and/or targeting capabilities, which airborne platform is deployed at selectable altitudes utilizing an airborne vehicle capable of carrying aloft payloads, e.g., sensors, most preferably electromagnetic signal sensors such as radio frequency (RF), electro-optic (EO), infrared (IR), or radio communications, or transmission devices, including, e.g., countermeasures and LASER targeting, or systems that employ both transmission and reception of electromagnetic waves, e.g., radar of the various types used in civilian and military applications.

It is further an object of the invention to provide a tethered payload system with a platform that overcomes the line-of-sight restrictions and endurance restrictions resulting from current surveillance system power requirements while requiring minimal manpower to operate.

According to an aspect of the invention, the tethered payload system operates as the interface platform for operation of the payload situated upon an airborne vehicle, for example, an autogyro, tethered to an in-motion host vehicle, either a maritime or ground vehicle. The tethered payload systems include the airborne vehicle, a payload sensor suite, a launch and recovery system, a data aggregation subsystem (DAS), Payload Sensor Human Machine Interface (HMI), and payload power system. The tethered payload system design is scalable to address smaller or larger payloads, as well as smaller or larger host vehicles accordingly.

According to another aspect of the invention, the tethered payload system includes a novel data aggregation subsystem (DAS) that is capable of multiplexing/demultiplexing analog radio frequency (RF), analog and digital video, Ethernet, and discrete voltage signals, e.g., Transistor-Transistor Logic (TTL), over a full-duplex fiber-optic link. A software application packages and distributes sensor data to the host vehicle's command and control center, or a human machine interface (HMI).

The HMI may be made from a combination of COTS and custom software. The HMI host computer performs mass storage of sensor data provided from the vehicle payloads, and may also be configured to send the sensor data to a control center of the host vehicle or to another host-vehicle sensor management system. Dependent on payload, the HMI may also perform basic sensor-data filtering and electronic ID functions.

According to an aspect of the invention, a tethered payload system receives power, signal, and other electrical-type support, e.g., lightning protection, through a tow cable to a power conditioning and signal distribution center on the airborne airframe platform. The power conditioning and signal distribution center provides power to the payloads, and dependent upon the needs of the users on the host vehicle or the payloads themselves, the distribution center can selectively provide relatively more or less power. As an option, batteries can be used onboard the tethered payload system to augment or replace cable provided power in smaller configurations. The tow cable also can provide lightning protection by including a braided shield electrical conductor line electrically grounding the airframe to earth ground through the host vehicle.

According to still another aspect of the invention, a method for interaction with an environment around a vehicle comprises providing an airborne platform connected by a tether to the vehicle. The airborne platform remains aloft at least in part by airflow relative to the airborne platform. Electrical power is transmitted from the host vehicle to the airborne platform via power conductors in the tether. The electrical power is received in airborne electronic payload circuitry on the airborne platform, and the airborne electronic payload circuitry uses the electrical power to engage in the interaction with the environment. Upward optical data signals are carried between the vehicle and the airborne platform via an optical fiber in the tether. The upward optical data signals received at the aerial platform are converted to received electrical signals and the received electrical signals are provided to the payload circuitry. Local electrical signals are generated in the payload circuitry responsive to the interaction with the environment. The local electrical signals on the aerial platform are converted to downward optical signals. The downward optical data signals are transmitted to the vehicle via the optical fiber, or via another optical fiber in the tether.

According to another aspect of the invention, a system provides a vehicle with electronic operations at a distance from the vehicle. The system comprises a tether connected with the vehicle and extending upwardly therefrom. An airborne platform is connected with the tether and secured thereby so as to remain aloft in an area of the vehicle at least partly by airflow relative to the aerial platform. The airborne platform has airborne electronic payload circuitry supporting the electronic operations, and the tether includes an electrical conductor supplying electrical power from the vehicle to the aerial platform. The tether includes at least one optical fiber linked with the airborne electronic payload circuity and with electronic base circuitry on the vehicle. The optical fiber in the tether carries optical data signals to the airborne platform from the vehicle or to the vehicle from the airborne platform such that the electronic base circuitry on the vehicle co-acts with the airborne electronic payload circuitry during the electronic operations.

According to another aspect of the invention, an airborne platform provides electronic surveillance, communication or electronic warfare or defense capabilities. The airborne platform comprises an autogyro configured to be secured to an end of a tether having conductors carrying AC current and optical fibers carrying optical signals. The autogyro includes a frame supporting a rotor with rotor blades providing lift from passing air, and a stabilizer structure with control surfaces. The frame supports a generally cylindrical module supporting therein payload electronics configured to support the electronic surveillance, communication or electronic warfare or defense capabilities and avionic electronics controlling flight operation of the autogyro. The module receives the AC current and the optical signals from the tether. The module has a power converter converting the AC current to DC current and supplying the DC current to the payload and avionic electronics, and a signal converter converting the optical signals into electrical signals and transmitting the signals to the payload and avionic electronics.

According to still another embodiment of the invention, a system links a round vehicle with an airborne platform. The system comprises a tether having a mechanical portion providing sufficient tensional strength for retaining the airborne platform connected by the tether to the ground vehicle. A metallic electrical conductor extends from a first end of the tether to an opposing second end of the tether, and it is configured to transmit AC current having a voltage of at least 400 volts and a power level of at least 600 watts. At least one optical fiber extends from the first end to the second end of the tether. There are first and second converters at the first and second ends of the tether, respectively. Each of the converters comprises an electrical connection receiving incoming electrical signals, and an electrical-to-optical conversion unit connected with the electrical connection and converting the incoming electrical signals to outgoing optical signals and transmitting the outgoing optical signals over the optical fiber. The converter further comprises an optical-to-electrical conversion unit receiving incoming optical signals transmitted through the optical fiber and converting those incoming optical signals to outgoing electrical signals and transmitting the outgoing electrical signals to the electrical connection.

Payload and control data is transmitted and received via fiber-optic cable embedded within the tow cable. This method of transmission provides a secure data link with a low-probability of detection or interception, as well as being resistant to counter-measure jamming.

Other objects and advantages of the invention will become apparent from the specification herein.

### BRIEF DESCRIPTION OF THE DRAWINGS

FIG. 1 is a schematic diagram of a vehicle, here a sea-going vessel, employing a system according to the invention.

FIG. 2 is a graph showing the relationship between the height of a sensor and the distance to the visible horizon at that height.

FIG. 3 is an elevational-view diagram of an autogyro for use as an airborne platform according to the invention.

FIG. 4 is a plan-view diagram of an autogyro for use as an airborne platform according to the invention

FIG. 5 is a schematic diagram of a system according to the invention.

FIG. 6 is a diagram of the tether of the system of FIG. 5 and its connections.

FIG. 7 is a cross-sectional view of the tether.

FIG. 8 is a diagram of an exemplary set of payloads with supporting systems in the base vehicle.

FIG. 9 is a diagram of the optical fiber communication signal conversion and de-conversion according to the invention.

FIG. 10 is a diagram of an exemplary converter converting electrical signals to and from optical signals in the optical fibers of the tether.

FIG. 11 is a diagram of the launch and recovery platform.

FIG. 12 shows the steps of launch and recovery of the vehicle using an articulable arm and platform arrangement.

FIG. 13 is a perspective view of an alternate embodiment of the autogyro.

FIG. 14 is a side view of the aft cylinder of the autogyro according to the invention.

FIG. 15 is a cross sectional view as in FIG. 14, showing the interior structures in the cylinder.

FIG. 16 is a detail view of the solenoid and watertight closing structure on one end of the cylinders.

FIG. 17 is a side elevational view of another alternate embodiment of the autogyro.

FIG. 18 a top view of the autogyro of FIG. 17.

FIG. 19 is a front elevational view of the autogyro of FIGS. 17 and 18.

FIG. 20 is a diagram illustrating a converter in which more than one signal is transmitted over an optical fiber.

### DETAILED DISCLOSURE

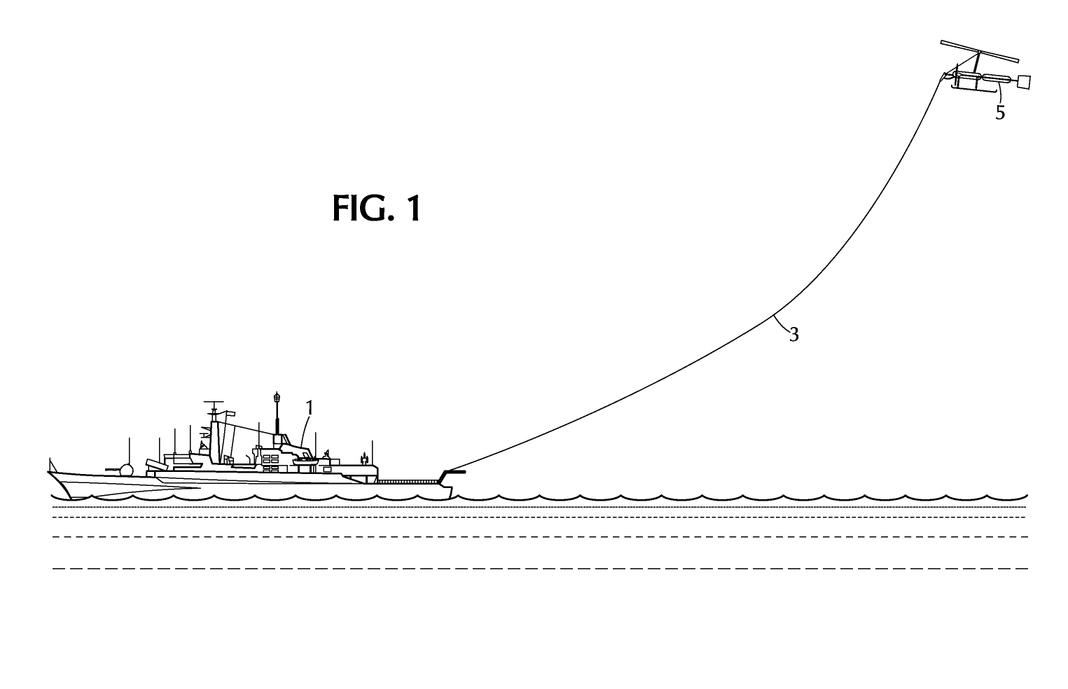

Referring to FIG. 1, a host vehicle, in the diagram sea-going vessel 1, draws behind it a tether line 3. A small, unmanned airborne vehicle 5, for example an autogyro, is towed by the tether line 3. The water-borne vessel 1 may be of any configuration, and may be as small as an 11-meter Rigid Hull Inflatable Boat (RHIB), or any larger water-borne or sea-going platform, provided that it can maintain a requisite minimum speed to keep the vehicle aloft. The host vehicle 1 may also be a land vehicle that moves under power on land, drawing the airborne vehicle behind it.

The autogyro typically has a simple unpowered rotor blade, and the host-vehicle forward motion produces a relative wind-speed with respect to the autogyro that generates lift without the need for additional power being generated, which provides operational endurance of the airborne vehicle 5 aloft. At times there may be sufficient wind at the system's operating altitude that it can remain aloft with little to no forward motion of the host vehicle.

The maximum altitude of operation of the airborne vehicle 5 is dependent on a number of factors, including tether length, relative wind speed, payload weight, the desired sensor altitude, and the operating capabilities of the autogyro used. Generally, the operational altitude range of the system is from 50 feet to approximately 5,000 feet. However, for an airborne platform drawn by a ground vehicle, e.g., a Humvee, the practical operational altitude of the airborne vehicle is up to approximately 800 feet. Some maritime applications take advantage of an altitude up to 5,000 feet. However, an 800 foot elevation markedly improves the operation of surveillance in rough terrain, and operation at a range of up to approximately 2,000 feet or 4,000 feet also provides a substantial advantage.

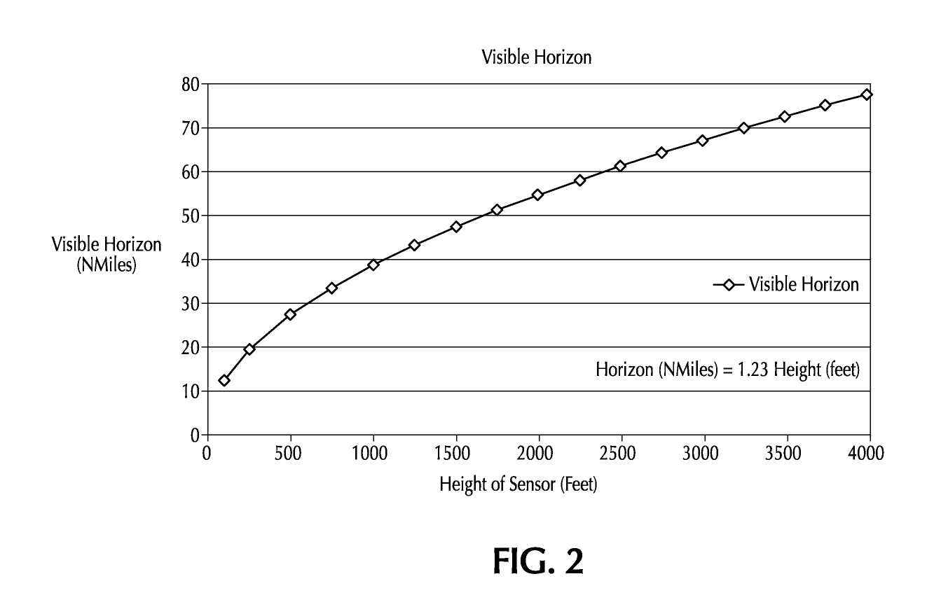

The graph of FIG. 2 shows how the visible horizon can be extended for sensor detection as a function of the airborne vehicle's altitude. A usual line-of-sight visible horizon for a ship at sea with a sensor on the ship fairly high above the water is about 14 nautical miles. The horizon for radar is slightly more than that. An elevation of the sensor to even about 1500 feet more than triples that distance to horizon to almost 50 nautical miles. Range extensions of greater than three to one are therefore easily achieved by the system of the invention.

The autogyro used for the platform may be any of a number of autogyros available on the market. The autogyro used in the invention is preferably one that is capable of remaining aloft indefinitely due to low power demands for maintaining itself stably at a predetermined altitude. To accomplish this, the autogyro has responsive flight control electromechanical mechanisms and other systems well known in the art that are controlled by flight control avionics electronic circuitry on the vehicle. That electronic circuitry acts responsive to flight control data signals sent to the airborne vehicle over communications lines in the tether, and allows for control of the flight of the vehicle form the base vehicle. Alternatively or at the same time, the flight control avionics electronics of the airborne vehicle may have a flight control system or autopilot system on board the vehicle that automatically performs control functions once initialized and does not require direct commands from the base vehicle.

The autogyro provides lift starting at a predetermined minimum operating speed, and is operational for flight at any wind speed above that, up to a very high maximum relative wind speed. The minimum operating speed may be 5 knots or greater, but, especially where a large payload is involved, minimum operation speeds may be about 8 knots. The autogyro can operate at relative wind speeds well above the minimum speed, up to about 90 knots.

In addition, the autogyro may have systems that can be briefly powered to provide propulsion during launch or landing if necessary, when the requisite relative wind speed is not immediately available. Similarly, these positive propulsion systems, e.g., auxiliary propellers, may be activated for a short period if the host vehicle temporarily stops its movement on the surface or changes its direction. Because the tethered payload system employing an autogyro is not weighed down with large engines and fuel, it has a reduction in size that equates to a reduction in radar cross-section, thereby providing additional stealth during operation without associated loss in surveillance capability.

The autogyro is capable of supporting the weight of the payload, i.e., the sensor or other elevated electronics deployed in the aerial platform. This weight is at a minimum about 25 pounds, although for some applications a payload up to 75 pounds or even to 150 pounds may be required. In fact very large payloads, e.g., 2,000 pounds, may be accommodated by analogous systems scaled up to support the additional force loads.

The autogyro of the preferred embodiment is much more stable than other systems that may be employed to create an airborne platform, such as a parasail or a kite. Stability is important, if not critical, to optimal operation of the elevated payload, and is an added benefit of use of the system of the invention with a vessel in rough seas, since the air above the ocean is typically not as turbulent as the water surface. The aforementioned other approaches, i.e., kites or parasails, are also generally larger, require more on-deck personnel for handling, and more visible, as well as requiring more vessel deck space for deployment, than an autogyro.

An Embodiment of the Autogyro

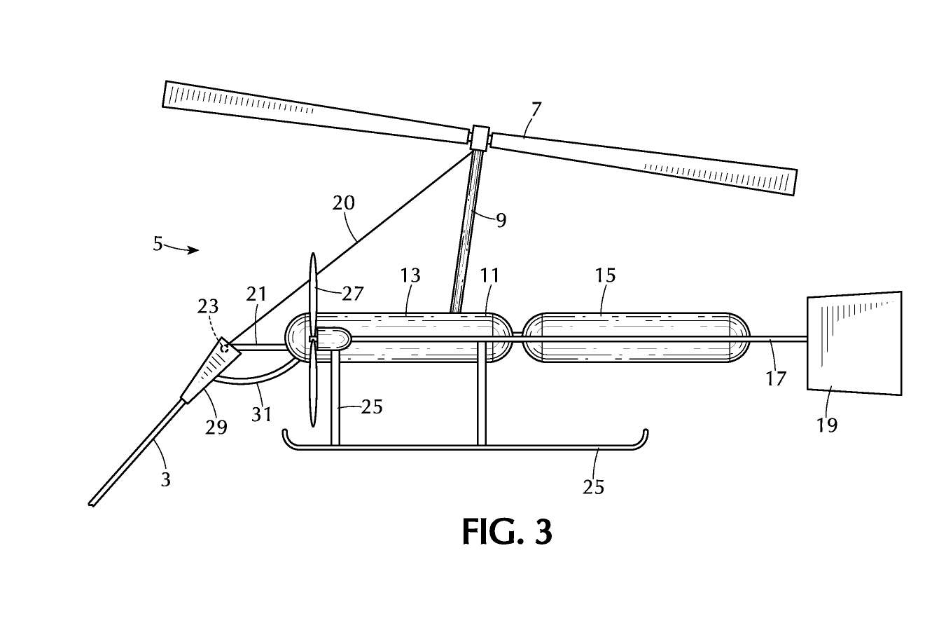

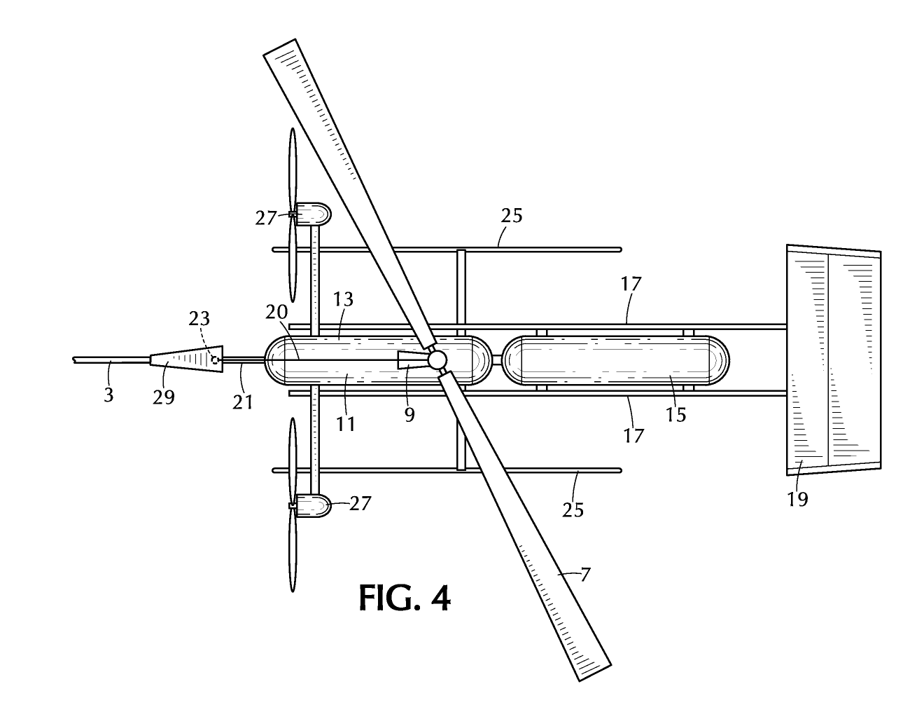

FIGS. 3 and 4 illustrate the general configuration of an autogyro for use according to the preferred embodiment. The airborne vehicle 5 comprises a main rotor blade assembly 7 on a mast 9 extending upwardly from the body 11 of the vehicle 5. Two blades are shown, but a three- or four-blade autogyro may also be employed.

The body 11 comprises two aligned generally cylindrical forward and rear modules 13 and 15 that house the operational electronics for the vehicle 5. Nose member 21 extends forward from front module 13, and is pivotally connected with the end of tether 3 by a pivotal connection 23. Cable 20 links this pivoting point to a location on the mast 9 for support and transmission of loads in the vehicle 5. The modules 13 and 15 are supported between longitudinal members 17 that extend rearward to support a tail structure 19 that may have movable control surfaces for flight control, as is well known in the art. The rotor 7 may also be adjusted in various ways known in the art to adjust the flight parameters of vehicle 5.

A skid structure 25 extends downward from the body 11 and supports the vehicle 5 when on the ground or the deck of a vessel or other vehicle. Optionally, auxiliary propulsion systems 27 are supported on the vehicle to provide temporary propulsion when relative wind speed drops temporarily below the minimum operational speed.

The tether 3 is coupled to the vehicle 5 at pivot connection 23, and the force required to draw the vehicle 5 along at operational wind speed is transmitted to the vehicle at this point. The tether 3 is made up of at least two components structurally, i.e., a mechanical cable that under tension draws the vehicle 5 behind the host vehicle, a data connection, preferably fiber optics, and an electrical connection, preferably copper, that provides a data and power link between the vehicle 5 and the host vehicle. At the aerial platform end of the tether 3, these components are separated, with the mechanical cable linking to connection 23, and tie data link lines 31 extending to the first module 13. A protective cone structure 29 may be provided to cover and protect connection 21, as well as the separation of the power and data lines from the mechanical cable portion of the tether cable 3.

System Configuration

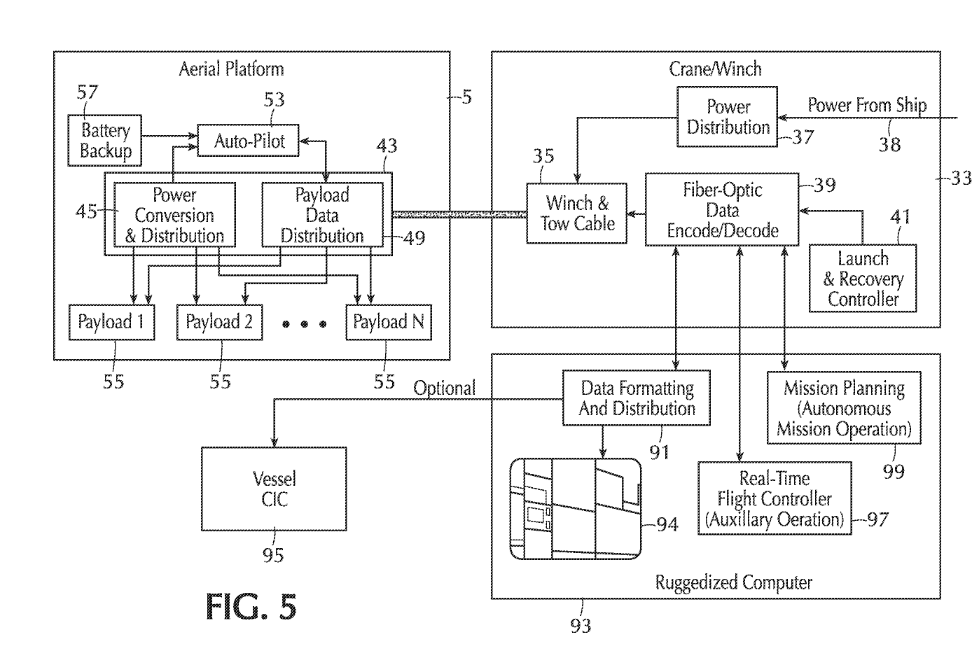

FIG. 5 shows a diagram of the components of the system. The aerial platform or vehicle 5 is connected via the tether 3 to a winch system 33 on the base vehicle 1.

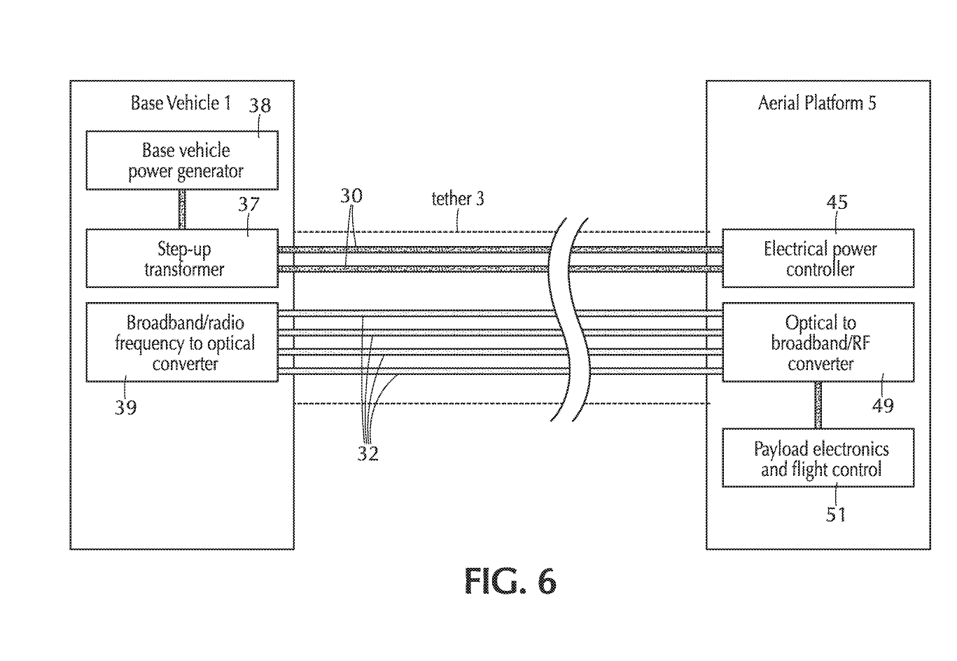

As best seen schematically in FIG. 6, the tether 3 of the preferred embodiment comprises two electrical conductor wires 30, and four optical fibers 32 extending the full length of the tether 3. One end of the electrical conductors 30 is connected with a step up transformer or power conversion distribution unit 37, which receives power from a power generator 38 associated with the base vehicle 1. The distal end of the electrical conductors is connected with an electrical power controller 45 in the aerial vehicle 5, which receives the power and distributes it to the various systems of the aerial vehicle 5.

The optical fibers 32 are each connected at one end thereof with a broadband or radio frequency (or other electrical signal format) converter 39 or 49 that converts the electrical signal received to light and transmits it on one or more of the optical fibers 32. At the distal ends of the optical fibers 32, the signal is converted back to broadband, radio frequency (i.e., RF), or whatever other format was employed, by converter 39 or 49. The resulting data or other electrical signals are supplied to the operational circuitry 51 of the aerial vehicle 5, and transmitted to either the payload of the vehicle 5 for electromagnetic interaction with the environment, or to flight control circuitry that operates the aerial vehicle 5 with servo-systems, as are well known in the art.

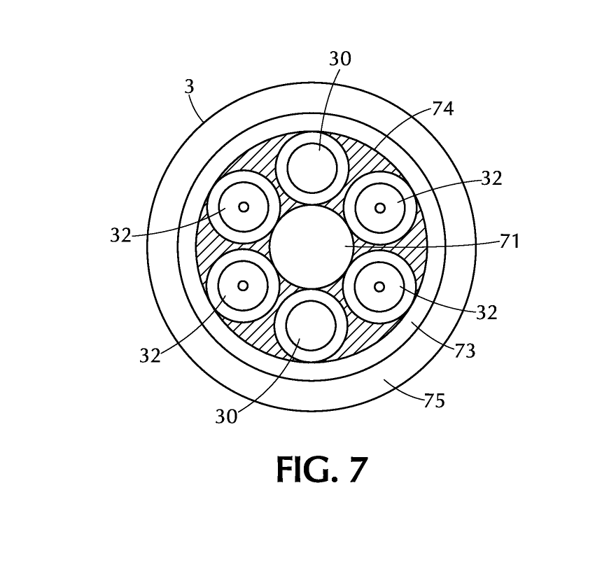

FIG. 7 shows a cross section of the tether cable itself. A central core 71 is surrounded by four jacketed single mode optical fibers 32 of about 2.3 mm diameter, and two insulated copper wire conductors 30 of 20 to 28 gauge. Filler material 74 is between these wires and fiber. A strengthening outer sheath 73 of a particularly high-tensile-strength synthetic fiber material such as Kevlar™ or Vectran™ surrounds these wires 30 and fibers 32, giving the tether 3 its tensile strength for drawing the aircraft in flight. An extruded nylon outer cover 75 surrounds the entire cable 3.

The tether cable 3 in the preferred embodiment has a diameter of about 0.38 inches in this embodiment and a breaking force of greater than 1000 pounds, and preferably at least about 4,000 and most preferably at least 5,000 pounds. The diameter of the cable 3 is preferably less than 0.4 inches, but potentially may be of any diameter, so long as the cable has the requisite high strength, low weight per linear length, and can contain the fibers and conductors needed for operation. It may also be provided with another conducting wire inside the member 73 or an external conductive sheath of the tether to carry electric charges from lightning down to be grounded at a grounded connection on the base vehicle. Its weight is preferably fairly low, e.g., about 60 pounds per 1000 feet or less. Suitable cable for practicing the invention may be readily obtained on the market, and may be obtained from; e.g., the Cortland Cable Co. in Cortland, N.Y.

Referring to FIG. 5, the winch system 33 includes a winch 35 that retains the tether or tow cable coiled and selectively reels it in or reels it out Preferably, the winch is hydraulic, remotely-operated winch, as is known in the art. It is preferably a 5 to 10 horsepower winch operating on 110 or 220 volt AC motor to drive the hydraulics. The winch is provided with a drum with fiber optic and electrical slip-rings or rotary joints, both of which are commercially available with numerous alternatives in the market. These joints provide for electrical and optical connection to the electrical and optical portions of the tether 3 substantially without compromise due to twisting during reeling in and out of the winch 35. The spooling drum preferably has capacity for thousands of feet of cable, preferably 3,000 feet or more, and is self-leveling. Alternatively, a manual or smaller electric winch can be employed in certain applications.

The winch 35 allows for the electrical connection from power conversion/distribution module 37, which receives power generated by the base vehicle 1 and provides AC current to the electrical conductor portions 30 of tether 3 through the above described rotation-allowing electrical connections. The power conversion/distribution module 37 converts the base vehicle power to 60 Hz AC current at a predetermined voltage that is appropriate to transmit up the tether to the airborne platform. The voltage is preferably in the range of 480 and 2000 volts, representing power of 700 to 2000 watts. The AC transmitted is two phases of AC, with each phase of the current being transmitted on a respective conductor 30.

Where the tether 3 has a lightning suppression conductor, i.e., an additional braid of conductor linking the aerial vehicle 5 to the base vehicle 1, the power conversion/distribution module 37 provides lightning suppression by connecting that lightning conductor to ground. Other power surges, e.g., static charges, are also monitored and suppressed by the power conversion/distribution module 37.

A fiber-optic data encode/decode unit 39 is connected with the fiber optic portion of the tether 3 by the rotation-allowing optical connections, and supplies light signals thereto that are transmitted to the vehicle 5, and receives optical light signals from the optical fibers of the tether 3, and converts them to a form usable by the base vehicle systems.

A launch and recovery controller 41 is connected with the winch 35 and the tether. The controller is a computerized control device that interfaces with and controls both the winch 35 and the aerial vehicle 5, as well as a launch and recovery platform, if present, on the base vehicle, as will be described below.

The aerial platform 5 at the opposite distal end of the tether 3 has circuitry 43 that connects with the electrical wires 30 and the optical fibers 32 of the tether 3. The circuitry includes power conversion and distribution circuitry 45 that receives the AC power from the conductors 30, and payload data distribution circuitry 39 that receives the optical signals from the optical fibers 32.

Power conversion and distribution circuitry 45 converts the high-voltage AC to DC by rectification and filtering so as to yield 28 volt DC power required for operation of the aerial platform. That DC power is transmitted to an autopilot module 53, and to the various ISR sensor or transmitter payloads 55 to power their operation. The autopilot 53 is preferably a modular auto pilot sold by Guided Systems Technology as a part of a flight control system for rotor aircraft sold under the name Hercules, with software stored thereon that is modified to operate with a rotor aircraft from a fixed-wing application, the usual configuration for that autopilot module. The DC power is also provided to the positive propulsion systems, e.g., DC motors driving counter-rotating propellers 27, and also a DC electric motor driving the main rotor 7, when the positive propulsion is activated.

Battery power, to the extent available, is also distributed by unit 45. A battery backup 57 is connected with the autopilot 53, so as to power the autogyro flight controls in the event of a loss of tether power, allowing the autogyro to descend in as controlled a fashion as possible. Limited battery power may also be provided to the payloads 55,

The payloads 55 are the portion of the aerial platform that interacts electromagnetically with the environment to provide the enhanced range afforded by the system of the invention. The payloads are any of a myriad of possible configurations. The pay loads are circuits providing the elevated transmission and/or reception of electromagnetic signals, or other more mechanical operations such as release of chaff, etc., and may include the relevant portions of systems including the systems and capabilities set out in Table 1 below.

The payloads used may also accommodate Ship Launched Persistent Integrated Countermeasures for Electronic Warfare (SPICE) applications, an elevated sensor program (ESP), or a LANShark Wi-Fi detection system. The payloads may also involve Anti-Submarine Warfare, Unmanned Underwater Vehicle operations, or virtually any type of electronic reliant intelligence gathering methods. The payloads are also preferably modular, so that they may be removed or swapped in and out readily depending on the particular situation requirements.

TABLE 1

| | |
|---|---|
| Product | Capability provided |

Sensors

| | |
|---|---|
| EO/IR Ball | Locate and observe objects |
| SAR | Locate, observe, and track objects |
| HF-UHF DF Sensor | Locate and identify UHF transmissions |
| SATCOM SIGINT | Locate and identity SATCOM transmissions |
| 802.11 SIGINT | Locate and identify wireless computer |
| | transmissions |

Countermeasures

| | |
|---|---|
| Radar warning system | Early warning of radar guided missiles |
| Passive missile warning | Early warning of missile launch |
| Active missile warner | Early warning of missile launch |
| IR CM | Infrared countermeasures |
| Radar jammer | Jamming of hostile radars |
| Radar decoys/missile | Seduction of radar guided missiles |
| homing seducer | |
| Laser warner | Early warning of laser guided missiles |
| Chaff/flare dispenser | Radar countermeasures |

Others

| | |
|---|---|
| Comms relay | Allows line of sight extension of commu- |
| | nications |
| Target designator | Allows designation of targets at farther |
| | ranges |

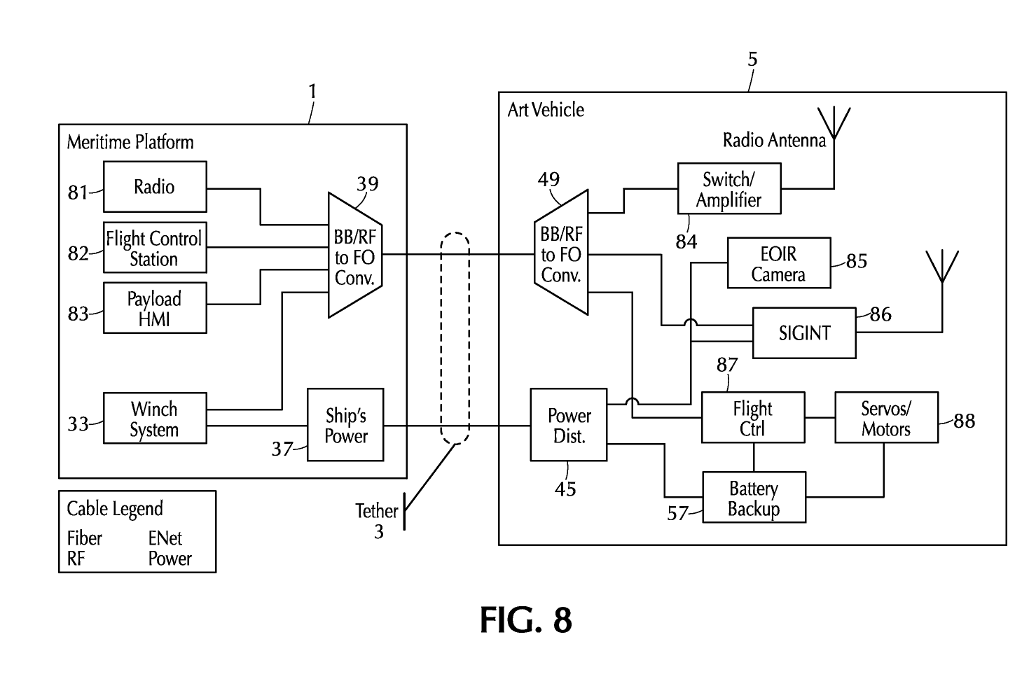

Payload data distribution circuit 49 converts the optical signals from optical fibers and back again. Referring to FIG. 8, in an exemplary combination of payload features, the ground vehicle 1 may generate electrical signals from a radio 81, a flight control station 82, and a payload HMI 83 allowing for control instruction inputs. These are all transmitted as electrical signals to converter 39, sent up tether 3, and the re-converted to their original form by converter 49, and are directed to the switch/amplifier and antenna of the radio payload 84, an EOIR camera 85 or a SIGINT payload 86, and the flight control signals are directed to the flight control circuit 87 of the aircraft, which sends appropriate signals to the local servos 88 that control the autogyro control surfaces, rudders, stabilizers, rotor blade angles, etc., as is known in the art.

Signals also proceed in the reverse direction. Video signals from the EOIR camera 85, incoming radio communications from radio antenna 84, and input from the SIGINT module 86 are converted to optical signals by converter 49 and sent through the tether 3 down to the base vehicle, where they are converted back to electrical signals by converter 39 and transmitted to the relevant modules, e.g., the radio 81, or the payload HMI, which stores the incoming data. The HMI host computer performs fusion of sensor data for real-time mission analysis.

Processing of the incoming data signals is seen in FIG. 5. The electrical signal data from converter 39 is formatted and distributed by computerized module 91 running on a ruggedized computer 93 on the base vehicle. The data is preferably stored in a supported data storage device 94. Optionally, the data may be sent to the vessel Command Information Center 95 for review by personnel or another ship sensor management system. The data from certain types of payloads also may be filtered and subjected to certain identification functions.

The ruggedized computer also supports flight control program modules such as Hercules that include a real time flight controller 97, which allows a human user to manually control operation of the autogyro 5 when desired, and mission planning module 99, which allows the user to direct the autogyro to comply with a specified mission plan in autonomous operation, e.g., to remain at or move to certain altitudes.

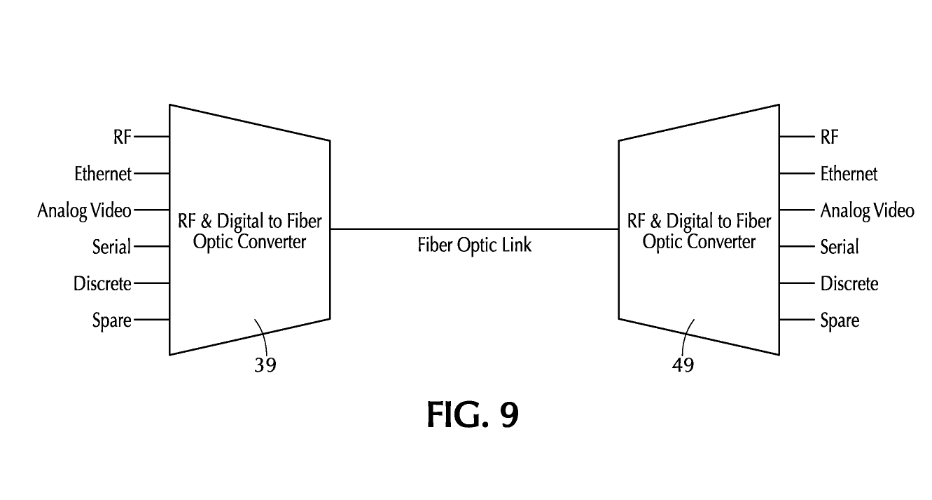

The conversion of electrical signals to optical signals transmitted in the optical fibers of tether 3, and then the conversion of those signals back to electrical signals is illustrated schematically in FIG. 9. Converters 39 and 49 are similar to each other, and together form a novel data aggregation system (DAS) that is capable of multiplexing/demultiplexing analog radio frequency (RF), analog and digital video, Ethernet, and discrete voltage signals (e.g., TTL) over a full-duplex fiber optic link. The converters 39 and 49 are commercially available multiplexing/demultiplexing components applied to convert electrical signals to relatively higher frequency optical signals transmitted in the tether, making their detection or interception very improbable and then de-convert the optical signals locally at either end of the tether for use as common-format electrical signals.

In the embodiment shown in FIGS. 6 and 7, the tether 3 has four independent optical fibers 32. The converters 39 and 49 may constitute a plurality of parallel individual converters each operatively associated with a respective one of the fibers 32 and converting electrical signals carried by electrical conductors, e.g., wires, on the respective base vehicle or aerial platform electronics to optical signals, i.e., light, transmitted over the associated optical fiber 32. The electrical signals may be any frequency of RF or data transmission protocols, or any type of electrical signal that can be carried on a wire.

The converters 39 and 49 also receive the light of optical signals transmitted in the fiber and converts it to electrical signals, which it transmits to electrical conductors or wires of the associated base vehicle or aerial platform electrical system connected with the converter.

Conversion from electrical signals to light is accomplished by any method well known in the art, e.g., by LEDs, and conversion from light to electrical signals may be accomplished by, e.g., applicable types of photoelectric effect. Data may be communicated in both directions along each fiber 32.

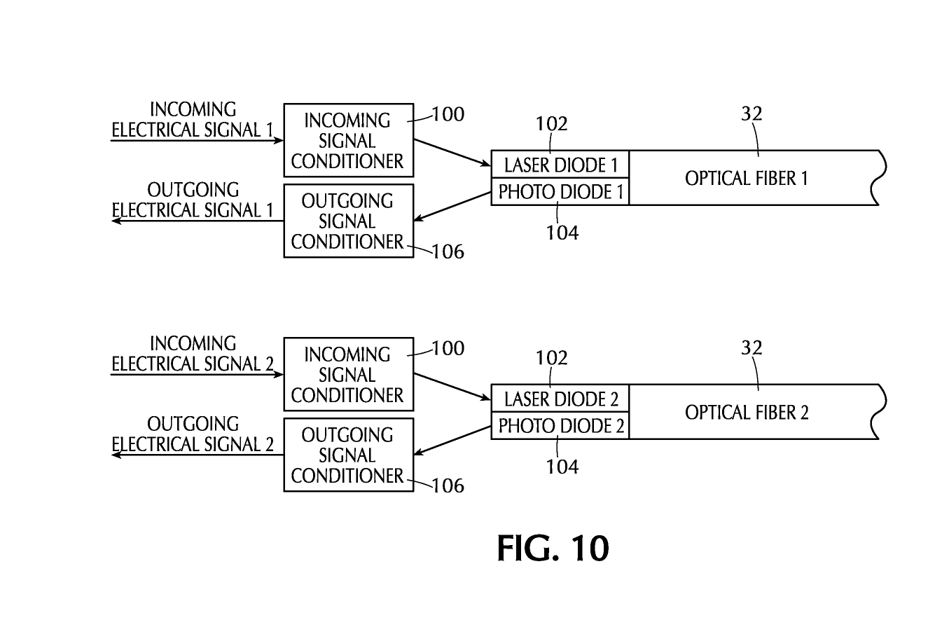

In one application, each fiber 32 carries a respective one of the data streams to or from the aerial platform 5, providing four data signals to the payload electronics and flight control or avionics electronics 51. An exemplary design for this application is illustrated in the diagram of FIG. 10, which shows two of the four optical fibers. It will be understood that the other two fibers are configured similarly to the two in the diagram, and also that the opposite ends of the optical fibers have similar arrangements for full duplex operation of the fiber in both directions.

Incoming electrical signals 1 and 2 are sent to the converter over metal, e.g., copper, wires that may be plugged into the converter by standard types of connectors for the given type of signal. The converter includes for each incoming electrical signal a respective incoming signal conditioner 100. The signal conditioner 100 is configured for the specific type of electrical signal received. The conditioner 100 may comprise a simple voltage amplifier for RF signals that raises their voltage to a level for conversion to optical, or a voltage adjustment or transformer that drops the voltage if the incoming signal is a simple digital data stream. Where the signal is a parallel electrical data signal, as in, e.g., Ethernet signals, the conditioner 100 converts the parallel signals into some sort of serial data stream at a voltage configured to be converted to optical signals. The conditioned electrical signals are then transmitted via a wire in the converter to a laser diode 102 that receives the conditioned signals and generates corresponding light that propagates into and through the associated optical fiber 32 to its opposite end.

The opposing end of the fiber is essentially the same as the transmitting end, and it includes a photo diode 104 that receives light from the associated optical fiber 32 and produces from it outgoing electrical signals, which are transmitted by wire to an outgoing signal conditioner 106. The outgoing signal conditioner 106 performs essentially the reverse of the incoming signal conditioner 100, e.g., it drops the voltage of an RF signal, increases the voltage of a digital data stream, and reconfigures a serialized Ethernet signal back into a parallel Ethernet signal at the proper voltage. The result is outgoing electrical signals that are transmitted back on electrical connections or wires that are the same as the corresponding-format incoming signals, or via different electrical connections.

If more signals are required by the functionality of the aerial platform 5 than the number of optical fibers in the tether, the signals may be multiplexed so as to be transmitted as optical signals together on the same optical fiber 32. The multiplexing may be by any appropriate multiplex protocol, such as time or frequency multiplexing, as is well known in the communications arts.

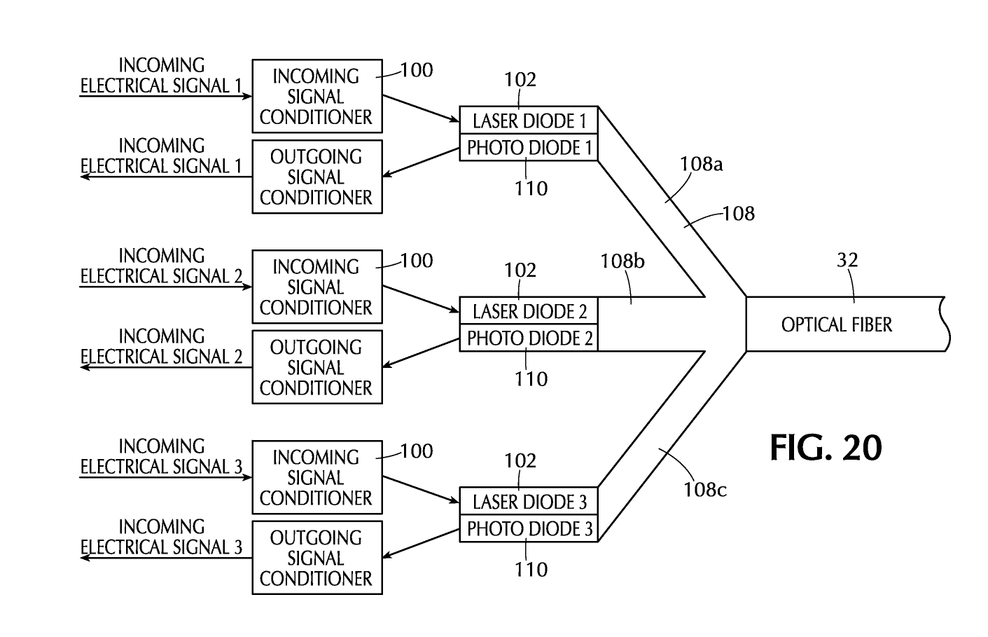

One design for accomplishing this is illustrated in FIG. 20. As with the embodiment of FIG. 10, a plurality of incoming electrical signals 1, 2 and 3 are supplied to the converter, and each is carried by wire to an incoming signal conditioner 100 that is configured for that type of signal to render it suitable for conversion to optical, as described above in regard to FIG. 10. The conditioned signal is carried by wire to a respective one of laser diodes 1, 2 or 3, identified as reference number 102, which diodes 102 convert the conditioned electrical signal received electrical signal to an optical light signal, as described above.

The optical signal so generated is transmitted to an optical combiner/splitter 108, which is a structure usually made of optical glass and well known in the art for combining optical data signals. Combiner 108 receives the optical signals form incoming electrical signals 1, 2 and 3, and transmits them together over optical fiber 32. To do this, the laser diodes 102 are each selected so that the each produce light only of a respective preselected range of wavelengths that will not create interference with the optical signals generated for the other signals being transmitted on the same optical fiber 32.

The opposite end of fiber 32 has a similar arrangement and a combiner/splitter 108. The light in the fiber 32 is received in component 108 and it propagates into three branches 108a, 108b and 108c, with the light of all of the optical signals being split into three parts each containing all of the optical signals. At the end of each branch 108 a, b or c, the light reaches a respective photo diode 110. The photo diodes 110 are configured to convert only the optical signals corresponding to the given signal type that it corresponds to. This may be accomplished by providing a filter in the photo diode filters out all light except the specific range of wavelengths of the associated signal, or by preselecting a photo diode 110 that is only responsive to that specific range of wavelengths.

The photodiodes 110 convert the respective range of wavelengths of the optical fiber light into a respective outgoing signal that is transmitted by wire to the corresponding outgoing signal conditioner 106, which operates as described above to condition the raw electrical signal from the photo diode 110 into an outgoing electrical signal of the proper voltage, data format, etc., for that type of signal. These outgoing signals are transmitted by the same or different electrical connections as provide the incoming signals of the same type.

In the preferred embodiment, the converters at both ends of the tether are the same. A variety of arrangements can be envisioned besides the ones here illustrated. Also, other methods of multiplexing known in the art may be employed as well to combine two or more converted electrical signals along one optical fiber in the tether.

Launch and Retrieval System

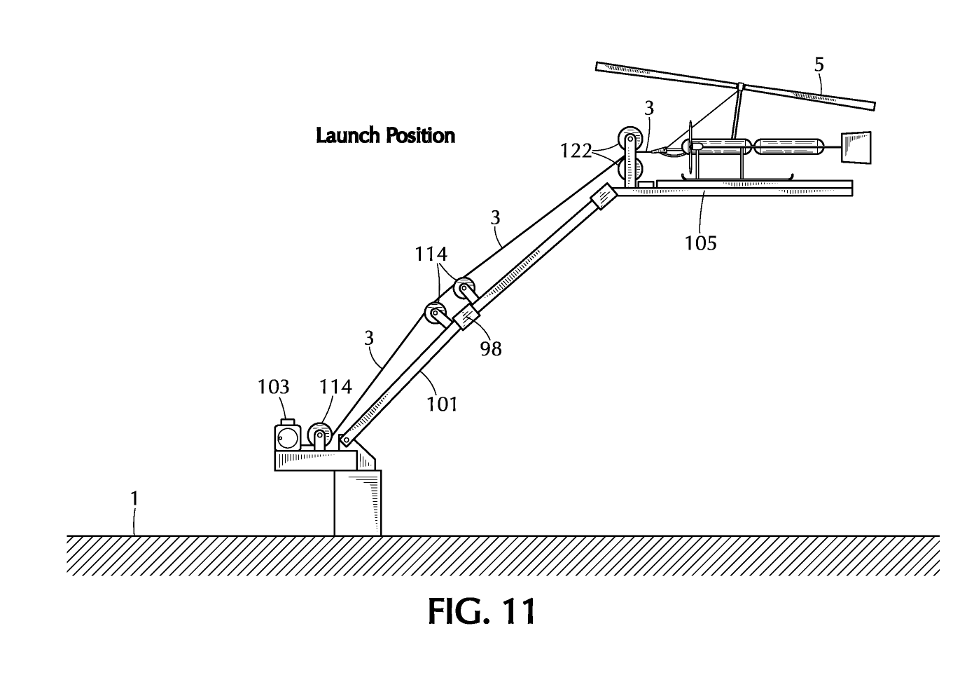

Referring to FIG. 11, a launch and retrieval system consists of a host vehicle, particularly a vessel, having mounted thereon capture/positioning arm 101 supporting horizontally supported platform 105, winch 103, tow cable (tether) 3 connecting to the autogyro 5. The winch 103 includes a spooling mechanism as described previously, and the power conversion/distribution unit and launch and retrieval controller (not seen in FIG. 11) as described previously are located at the winch area. The launch and retrieval system provides active compensation for host vehicle motion for coordinated launch and retrieval.

The capture and positioning arm 101 is a host vehicle mounted foldable aim that extends to provide a launch or capture position for the airborne vehicle. The arm 101 can be elevated or lowered, and it is selectably pivoted by operator-controlled hydraulics about a roughly longitudinal mid-center pivot connection 98 or two longitudinal portions; in either position, the platform 107 remains horizontal relative to the body of the host vehicle. The arm 101 directs the towing cable in a safe and controlled fashion, and can rotate 360° to allow optimal vehicle/vessel orientation. The extent of arm slew is monitored and limited to be tailored for the host vehicle layout. Automatic control coupling of the six (6) degrees of freedom of the air vehicle 5 to the capture mechanism allows for dynamic capture of the vehicle.

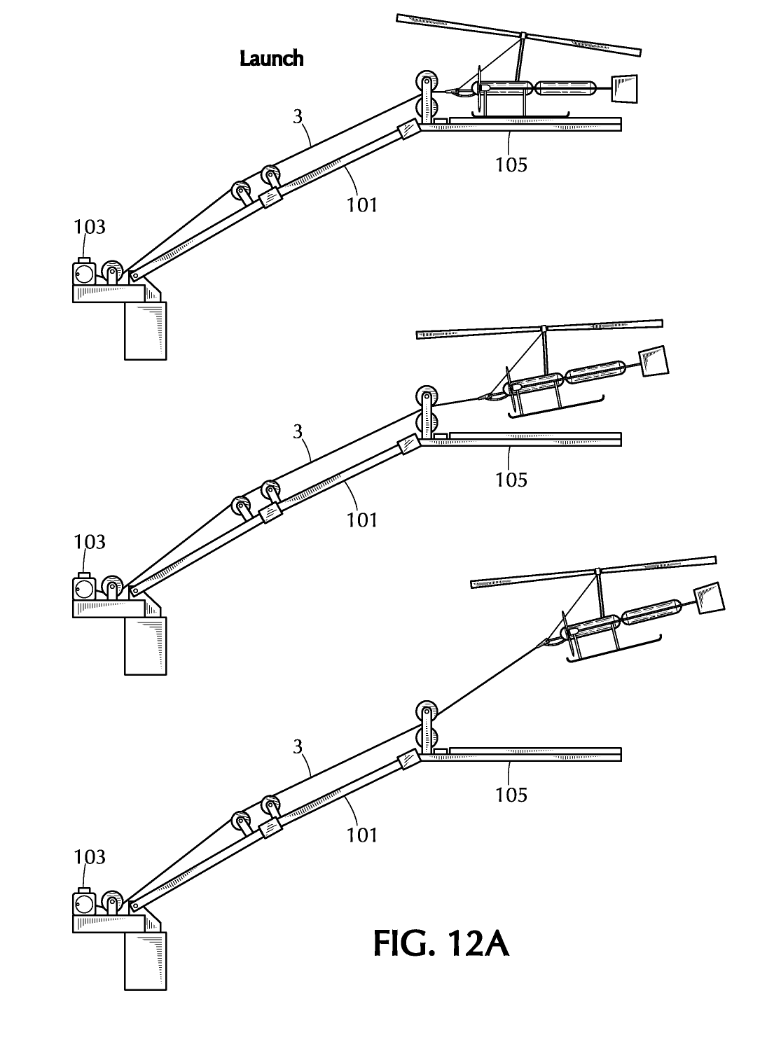

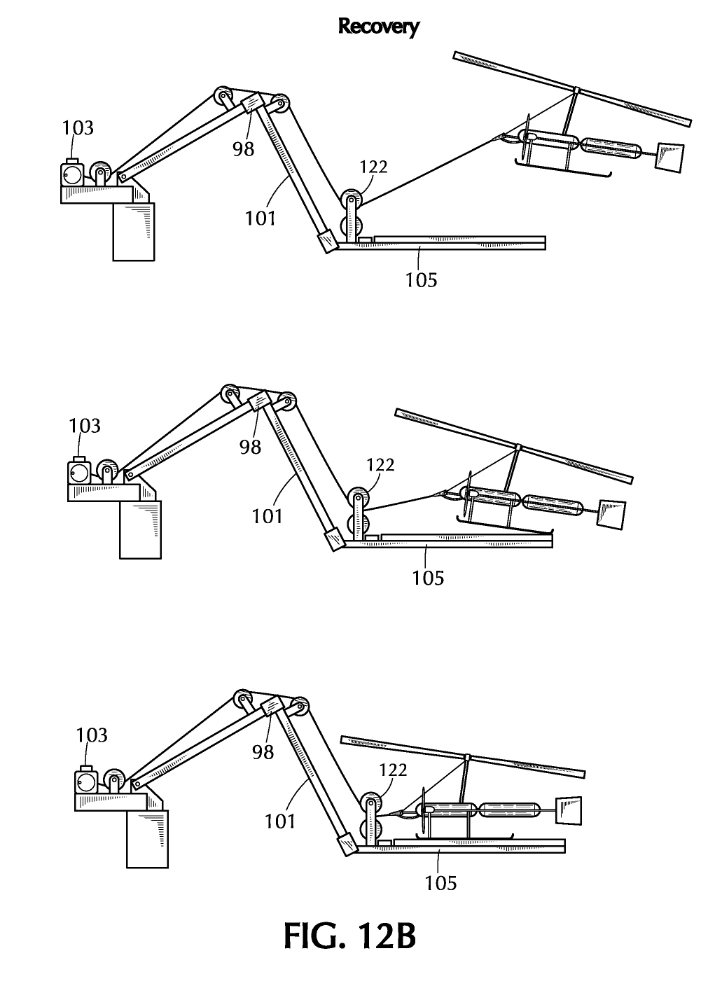

The tether 3 is controlled by a series of pulleys 114, and by a pair of pulleys 122 spaced up the arm 101. The tether 3 is reeled out from a point near the forward end of the platform 105, and pulleys 122 control the tether 3 at this area, with the upper pulley 122 preventing upward movement of the autogyro 5, especially in close proximity to the platform 105, essentially allowing the autogyro 5 to launch vertically up and rearward only, under full control, and to land on the platform 105 with purely forward and downward movement ending at the movable platform 105. The capture and release phases of the airborne vehicle are assisted by the capture platform as portrayed in FIG. 12. The Launch and Retrieval System is coupled to the airborne vehicle flight control system. This control system adaption dynamically adapts to host vehicle and airborne vehicle independent motion for controlled launch and retrieval. It also adapts to compensate for varying wind and direction. The winch has a powered drum for the fiber-optic/power tow cable, level-wind and rotary joints. The Launch and Retrieval System provides the necessary commands to the winch and the vehicle during the launch and recovery phase.

If a positive propulsion system is present, during the launch phase, the main rotor is spun up by a small motor to begin the autogyro autorotation, and the auxiliary propellers are also powered up to provide the counter-rotational forces needed against the main powered rotor (this is not necessary when the rotor is not powered). A flight control system, such as a system running Hercules software, senses whether there is sufficient lift and airspeed across the main rotor (via accelerometers and anemometer attached to the aircraft), and, responsive to a determination that the necessary wind speed is present, the flight control system, releases locking latches on the platform that hold the aircraft secured to the platform. Once airborne, and sufficiently far enough from the launching vessel, the Hercules assesses flight dynamics (wind speed airspeed, wind direction, altitude, and if the relative wind speed is viable for powerless flight, it will disengage the three motors. During the retrieval phase, the Hercules reengages the propellers and main rotor motor to provide the needed lift and maximize maneuverability. While the aircraft is being drawn into the capture platform (winched in) the Hercules maintains a positive pitch to keep the propellers clear of the capture platform. As the landing skids contact the platform deck, the latching mechanism thereon automatically locks the aircraft onto the platform, at which point the Piccolo will disengage all motors.

The flight system with Hercules software has a Built In Test (BIT) function that constantly performs diagnostics to assure functionality and mission readiness. Communications, servo actuators, data links, motor control, tether integrity are continuously checked and any functional discrepancy is reported.

The system flight controller easily controls the aircraft in flight, and during launch or retrieval. The flight controller is also used to build the predetermined flight parameters that will be followed during the mission.

Once the base vessel is outfitted, operating the system is simple and straightforward according to the following method steps:
1. Select payload configuration (payload pylori) and program mission parameters
2. Install payload pylori onto aircraft platform
3. Turn on the Piccolo auto pilot
4. Confirm from that the startup BIT has successfully run
5. Confirm that the pre-flight mission data is loaded
6. Enable preflight/launch sequence (sailing direction, wind speed deploy aircraft platform)
7. Authorize launch sequence
8. Deploy aircraft to desired altitude, distance and offset.
9. Monitor for automated system alerts while employing embarked sensor.

The system of the invention is designed for minimal or no maintenance and ease of use. There are no routine maintenance operations, beyond battery recharging or replacement, and therefore, no requirements for special or general purpose test equipment. An extremely low cost and high MTBF minimizes the need for spares or a repair facility. A modular design and construction of the aircraft facilitates any necessary repairs. The BIT routine provides a high degree of confidence that the auto-pilot and flight control functions are fully working.

FIG. 12 represents the system Launch and Recovery Arm in the both launch and recovery operations. Generally described, the arm 101 and platform 105 are elevated in the launch phase, and the tether is reeled out while the autogyro is piloted by the launching computer system, and guided to its operational altitude. In recovery, the platform 105 is generally lowered to its lowest position, and the autogyro is reeled in and piloted to a soft landing thereon.

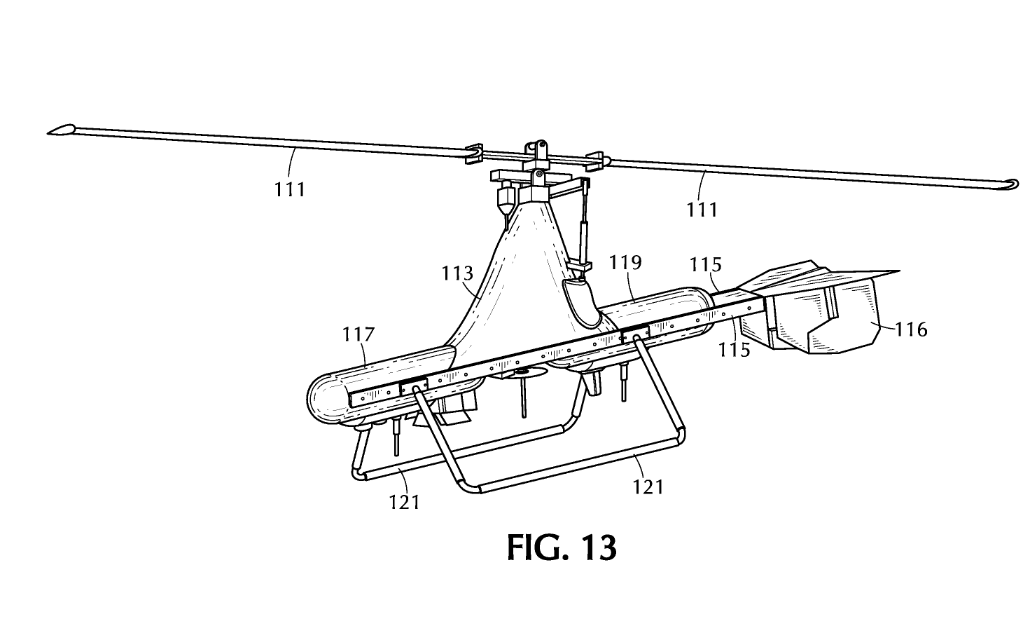

FIG. 13 shows an alternate embodiment of autogyro. This embodiment has two rotor blades 111 supported on a mast structure 113 of carbon fiber. The mast structure 113 is supported on side rails similar to the side rails 115 of the previous embodiment, except that they are tubular and of carbon fiber as well. A modified tail structure 116 has controllable stabilizers and rudders for control of the autogyro movement. Front and rear cylindrical tubes 117 and 119 are similar to those of the previous embodiment and are supported between side tubes 115. Landing skids 121 of carbon fiber are also connected to side tubes 115. The use of carbon fiber for most of the components further reduces the likelihood of detection, and also reduces the weight of the aircraft.

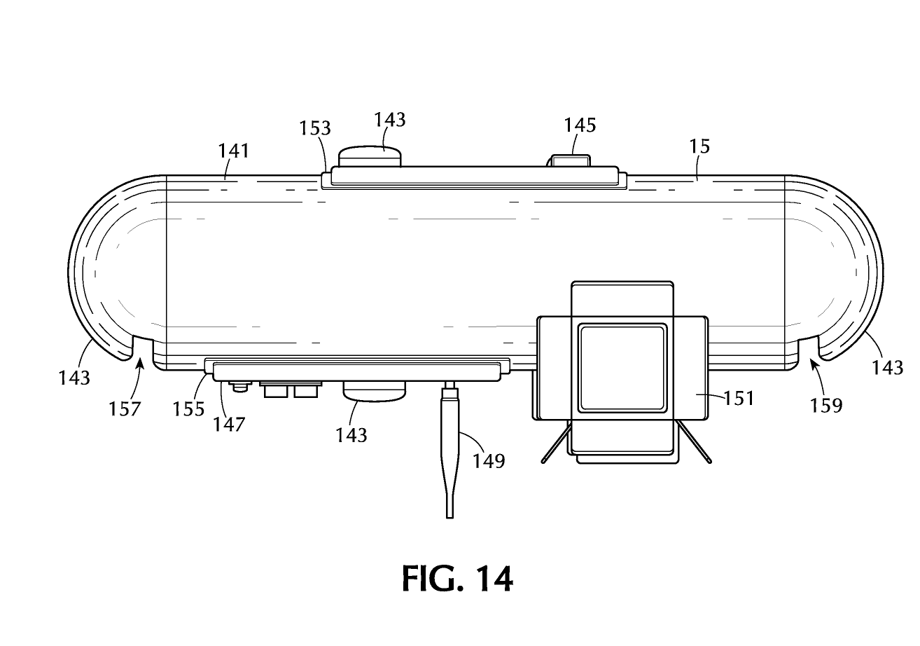

FIG. 14 shows an elevational view of one of the autogyro cylinders 15 or 119. The cylinder body 141 is a tube of carbon fiber material with a row of holes therein for connection to the rest of the autogyro, or for securing internal parts to the tube 141. The longitudinal ends of the tube 141 are each covered with a respective hemispherical cover 143. The connection between the covers 143 and the tube 141 is watertight.

A number of payload antennas and other structures 143 to 131 operatively associated with payload circuitry inside the cylinder pod 15 extend through the tube 141. The apertures in the tube 141 through which these structures extends are also sealed by surrounding sealing structures, e.g., composite bulkheads 153 and 155, so as to be watertight.

A great deal of heat is generated by the operation of the payload circuitry inside the cylinder 15. This heat is at least partially dissipated by allowing flow of air through the cylinder 15 between front and rear ventilation openings 157 and 159 in the hemispherical covers 143. These openings 157 and 159 are the only possible entry or egress for air or water into the cylinder 15.

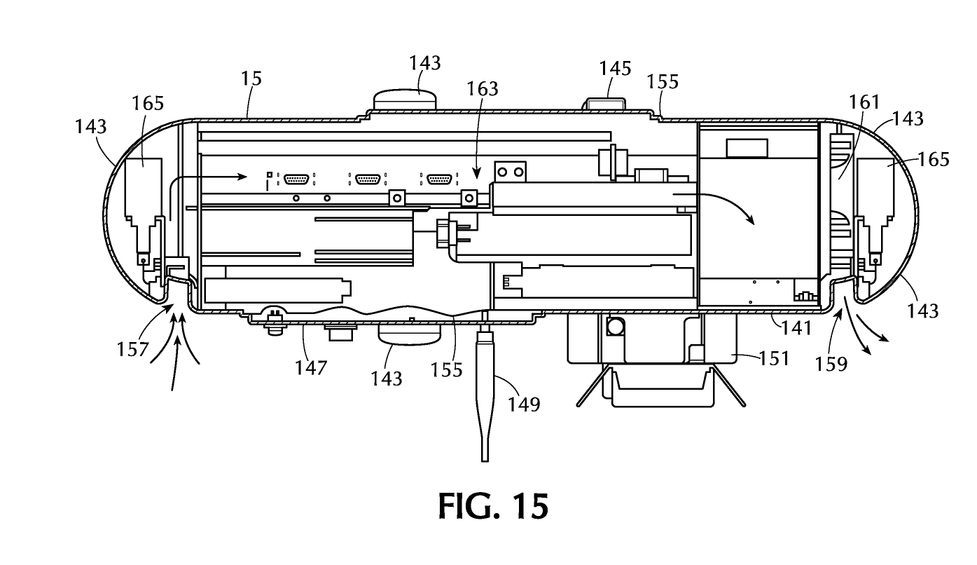

Referring to FIG. 15, cooling flow of air through the tube 141 is aided by a rotary fan 161 that is powered by the aircraft power control DC current. The fan 161 forces air to flow through the tube 141 over the payload circuitry generally indicated at 163. The circuitry 163 is preferably connected with heat sinks having heat dissipation vanes that transfer heat as effectively as possible to this airflow.

The payload circuitry 163 is potentially made up of very costly components that could be destroyed or damaged if water were to enter the cylinder 15, as, for example, if the autogyro were to crash into the sea. To guard against this, in each of the end covers 143, a solenoid 165 is supported. When activated, the solenoid clamps a door shut over the associated opening 157 or 159, sealing it with a watertight closure, and completely sealing the cylinder 15 against any entry of water that might damage the payload circuits 163.

The solenoids are connected with the flight controls so that, responsive to a determination of a catastrophic event, such as a total power failure or some other indication of an imminent crash of the aircraft that might involve hitting the water, the solenoids close the watertight doors and seal the cylinder.

In addition, a water sensor may be mounted adjacent each opening 157 or 159. In the event that there is contact with water, the water sensor will produce a signal indicative of the presence of water. Responsive to that signal, both of the solenoids 165 will release so as to seal watertight doors over openings 157 and 159, protecting the interior of the cylinder 15 from water incursion.

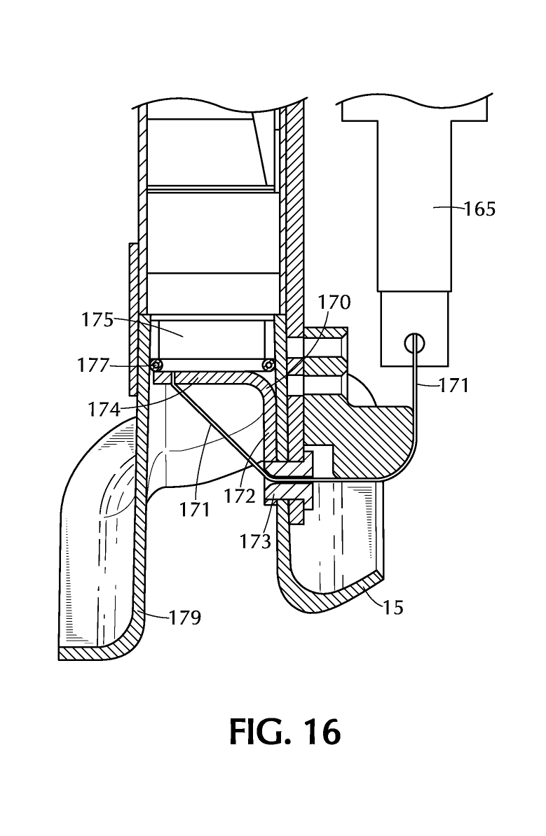

FIG. 16 shows the structure of the solenoid and the sealing apparatus in detail, with the watertight seal closed, i.e., preventing water from entering the cylinder 15.

The sealing door member 170 is of elastic flexible material, and it has a mounting portion 172 affixed to the vertical wall, a bend at its upper end, and then the sealing door portion 174. The material of the member 170 is elastomerically biased such that the sealing door portion 174 moves to the position shown, sealing the opening to the fan by covering the opening defined by the interior passage of tubular insert liner piece 175 and pressing against sealing gasket 177 to seal the opening. Liner piece 175 is fixedly supported in the passage, and it provides a shoulder surrounding the passage through it, to which shoulder the gasket 177 is affixed, whether the door 174 is closed or open.

At the start of operation, the solenoid 165 is actuated, which pulls on nylon coated rope 171 which extends through Teflon bearing 173 and is fixedly attached to the door sealing portion 174 of elastic part 170. This results in a pull on the sealing door portion downward away from its engagement with sealing gasket 177, opening the space in piece 175 and allowing air to flow through.

In the event of a power failure, the solenoid 165 releases, and the rope 171 is also released. No longer being held in the open position by rope 171, the elastic nature of the sealing door member 170 biases the sealing door portion 174 upward again, so that it covers the opening and seals in engagement with gasket 177. This clamps shut the access to the interior through the molded exhaust vent 179 in cylinder 15, protecting its contents.

The described structure is however purely exemplary, as other systems may readily be designed to accomplish this end of sealing the opening.

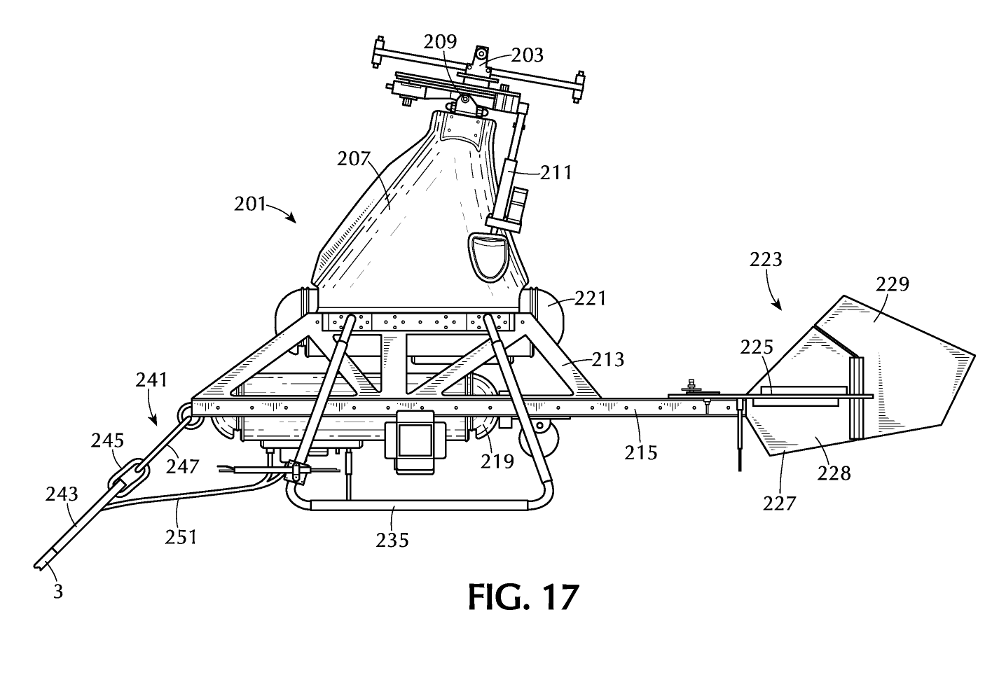

FIGS. 17 to 19 show another embodiment of autogyro for use in a system according to the invention.

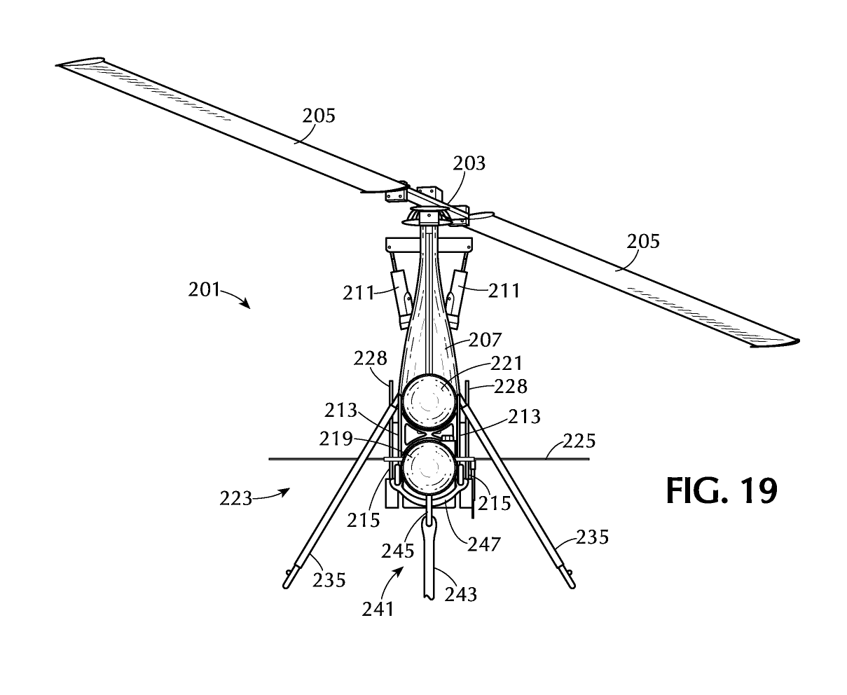

Referring to FIG. 17, the autogyro 201 has a rotor 203 with two rotor blades 205 (see FIG. 19) supported on a mast structure 207 of carbon fiber. The rotor 203 is supported so as to be pivotable relative to the mast structure 207 about pivot 209. The angle of the rotor 203 relative to the mast 207 is adjustable by the avionic electronics and controls of the autogyro 201, and the rotor 203 is moved to the determined angle by hydraulic cylinders 211, or similar devices, controlled by the autogyro electronics.

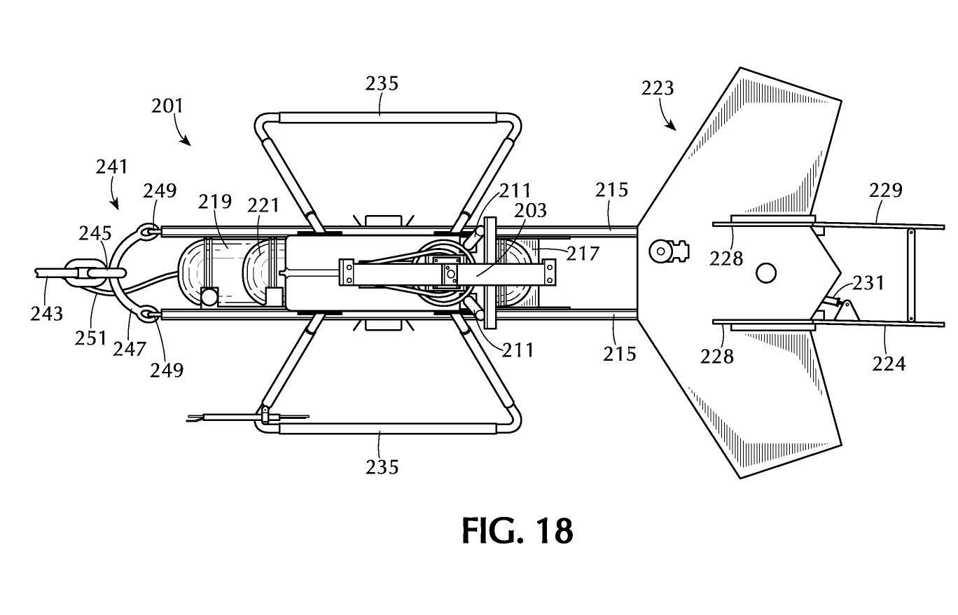

Mast structure 207 is secured at its lower end to left and right side frames 213, which at their lower ends are attached fixedly to, respectively, left and right side rails 215 similar to the side rails of the previous embodiment, that are tubular and of carbon fiber as well. A web 217, best seen in FIG. 18, is also connected with the lower ends of the side frames 213. The side frames 213 are substantially planar, and have cut-outs to reduce weight.

The web 217, side frames 213 and bottom of the mast structure 207 together define a space supporting therein cylindrical payload modules 219 and 221. The payload modules 219 and 221 are essentially the same as the payload modules 117 and 119 of the previous embodiment, and are affixed on their lateral sides to the side frames 213.

Module 221 is supported directly above and slightly rearward of the module 219. This renders the vehicle 201 more compact and structurally rigid, and the physical enclosure as well as the relative positions of the modules 219 and 221 provides more structural protection in case of an impact. The modules 219 and 221 are provided, as in the previous embodiments, with openings forward and aft that permit passage of air through the module so as to cool the electronics in it. In addition, the modules are provided with safety mechanisms that, responsive to detection of contact with water or other indication of a non-normal landing of the vehicle, e.g., a crash, close watertight doors that seal those openings so that each module becomes watertight.

The side rails 215 support a tail structure 223 at their rearward ends. The tail structure 223 includes a horizontal stabilizer 225 and a vertical tail section 227. The tail section 227 is formed of a pair of laterally spaced vertical plates 228 pivotably supporting rudders 229. Rudders 229 are tied to each other so as to move together, and are moved to the proper position for the flight conditions by a cylinder 231 controlled by the autogyro flight control electronics, either operating automatically or by an operator manual control at the base vehicle for control of the autogyro movement.

Landing skids 235 of carbon fiber are also connected to side frames 213. The skids 235 are formed of carbon fiber tubes 237 extending obliquely from brackets 239 to angle pieces 241 that connect with and support horizontal carbon-fiber cross tube 243. The mast 207, the side frames 213, the side rails 215, and the stabilizer and rudder are made of carbon fiber. The use of carbon fiber for most of the components of this embodiment reduces the likelihood of detection by electromagnetic sensors or radar, and also reduces the weight of the aircraft.

The mechanical connection part of the end of the tether is secured to a bridle structure 241 extending between the front ends of side rails 215. The upper end of the tether 3 is secured in a Kellems grip connector 243 secured by releasable link or karabiner 245 to a U-shaped bridle member 147, secured in turn by loops 249 to the front ends of the side rails 215. The electrical and optical parts of the cable 251 extend past this point and hook up to respective watertight connections on the underside of module 219.

Module 219 preferably contains the power and signal converters linked to the power and optical fibers of the tether. It also contains the payload electronics for the aerial platform.

Module 221 preferably contains the on-board avionics electronics for control of the flight operations of the autogyro. A further watertight cable extends from module 219 to module 221, and carries the DC current to it to power the avionics. The cable between the modules also transmits flight-command data signals sent up the tether from the base vehicle from module 219 to the avionics circuitry in the second module 221.

The terms used in this disclosure should be read as terms of description rather than of limitation, as those of skill in the art with this disclosure before them will be able to make modifications and amendments thereto without departing from the spirit of the invention.

What is claimed is:

1. A method for interaction with an environment around a vehicle, said method comprising:
providing an airborne platform connected by a tether to the vehicle, said airborne platform remaining aloft at least in part by airflow relative to the airborne platform;
transmitting electrical power from the vehicle to the airborne platform via a power conductor in the tether; and
receiving the electrical power in airborne electronic payload circuitry on the airborne platform, the airborne electronic payload circuitry using said electrical power to engage in the interaction with the environment; and
carrying upward optical data signals between the vehicle and the airborne platform via an optical fiber in the tether;
converting the upward optical data signals received at the aerial platform to received electrical signals and providing the received electrical signals to the payload circuitry; and
generating local electrical signals in the payload circuitry responsive to the interaction with the environment,
converting the local electrical signals on the aerial platform to downward optical signals, and
transmitting the downward optical data signals to the vehicle via the optical fiber, or via another optical fiber in the tether.

2. A method as described in claim 1, wherein the airborne platform is an autogyro having a rotor with blades that co-act with air so as to maintain lift for the autogyro.

3. A method as described in claim 2, wherein the electrical power comprises AC current, and the transmitting of the electrical power includes using a transformer on the AC current such that the AC current has a voltage in a range of 480 and 2000 volts and a power of 700 to 2000 watts.

4. A method as described in claim 3, wherein the electrical power is at least partly converted in the airborne platform to DC current.

5. A method as described in claim 2, wherein the electronic payload circuity is contained in one or more modules supported on the autogyro, said modules having forward and rearward openings therein configured so that air flows therebetween inside the module so that the payload electronics are cooled thereby.

6. A method as described in claim 2, wherein the module or modules are configured to close said openings so as to make the module or modules watertight in the event of a crash of the autogyro.

7. A method as described in claim 1, and further comprising converting electrical signals carried in electrical conductor circuitry in the vehicle to the optical signals.

8. A method as described in claim 1, wherein said generating of the local electrical signals comprises receiving electromagnetic signals and converting the electromagnetic signals to the local electrical signals.

9. A method as described in claim 1, and further comprising operating control avionics of the airborne platform based on the received electrical signals.

10. A method as described in claim 1, and further including sensing an aspect of the environment of the airborne platform with a sensor connected with the payload circuitry so as to generate sensor signals, and the generating of the local electrical signals comprising converting the sensor signals into the local electronic signals.

11. A method as described in claim 1, wherein the payload circuitry includes electronic or mechanical electronic warfare countermeasures that are initiated responsive to the received electrical signals.

12. A method as described in claim 1, wherein the tether comprises a plurality of metallic electrical conducting wires, a plurality of optical fibers and a load-bearing sheath extending between the vehicle and the airborne platform.

13. A method as described in claim 1, wherein the vehicle is a sea-going maritime vessel.

14. A method as described in claim 1, wherein the payload electronics are configured to provide electronic warfare or defense capabilities to the vehicle.

15. A system providing a vehicle with electronic operations at a distance from the vehicle, said system comprising:
a tether connected with the vehicle and extending upwardly therefrom;
an airborne platform connected with the tether and secured thereby so as to remain aloft in an area of the vehicle at least partly by airflow relative to the aerial platform;
the airborne platform having airborne electronic payload circuitry supporting the electronic operations; and
said tether including an electrical conductor supplying electrical power from the vehicle to the aerial platform; and
said tether including at least one optical fiber linked with the airborne electronic payload circuitry and with electronic base circuitry on said vehicle;
the optical fiber in the tether carrying optical data signals to the airborne platform from the vehicle or to the vehicle from the airborne platform such that the electronic base circuitry on said vehicle co-acts with the airborne electronic payload circuitry during the electronic operations.

16. A system according to claim 15, wherein the vehicle is a maritime vessel.

17. A system according to claim 16, wherein the tether comprises a tensile load bearing portion extending from the vessel to the airborne platform being of adequate strength to retain the airborne platform connected with the maritime vessel, a plurality of metallic electrical conductors, and a plurality of optical fibers, and
the system further comprises
a winch selectively reeling in or reeling out the tether, and
a stationary or movable platform on the vessel, said movable platform supporting the airborne platform thereon before launch and after recovery, said movable platform being selectively moved to a first elevated height and to a second height lower than the first elevated height;
wherein, during launch, the airborne platform is supported on the platform and the winch reels the tether out; and
wherein, during recovery of the vehicle, the winch reels the tether in.

18. A system according to claim 16, wherein the airborne platform is an autogyro connected to an end of the tether, the autogyro having a rotor and a frame supporting one or more generally cylindrical modules of carbon fiber material, wherein the electronic payload circuity is contained in said modules, said modules having forward and rearward openings therein configured so that air flows therebetween inside the module so that the payload electronics are cooled thereby, and the module or modules are configured to close said openings so as to make the module or modules watertight in the event of a crash of the autogyro.

19. A system according to claim 18, wherein the autogyro has structural members and control surfaces formed of carbon fiber material.

20. A system according to claim 16, wherein the electronic payload comprises one or more component systems selected from the group consisting of sensors detecting visible objects, electromagnetic detection system sensors, radar systems, passive or active missile detection systems, laser detection systems, communication jamming or radar jamming systems, electronic warfare countermeasures, communications relay, and target designation systems.

21. A system according to claim 20, wherein the electrical power is AC current having a voltage in a range of from 480 volts to 2000 volts, and the airborne platform supports therein a power distributer that converts the AC current to DC current at a lower voltage, and supplies that DC current to the electronic payload.

22. A system according to claim 21, wherein the optical fibers each have two opposing ends, one of the ends being proximal to the host vehicle and the other of the ends being proximal to the aerial platform, one of the ends having a first converter converting electrical signals carried in a first wire connected therewith to optical light signals transmitted in the optical fiber, and the other of the ends having a second converter converting the optical light signals in the optical fiber to electrical signals and supplying the electrical signals to a second wire connected therewith.

23. A system according to claim 22, wherein the first converter also converts optical signals in the optical fiber to other electrical signals, and the second converter also receives further electrical signals and converts them to other optical light signals in the optical fiber such that data may be transmitted in both directions in the optical fiber.

24. A system according to claim 17, wherein the tether further has a conductor configured to carry electricity from lightning in the event of a lightning strike on the airborne platform.

25. An airborne platform providing electronic surveillance, communication or electronic warfare or defense capabilities, said airborne platform comprising:
an autogyro configured to be secured to an end of a tether having conductors carrying AC current and optical fibers carrying optical signals;
the autogyro including a frame supporting a rotor with rotor blades providing lift from passing air, and a stabilizer structure with control surfaces;
the frame supporting a generally cylindrical module supporting therein payload electronics configured to support said electronic surveillance, communication or electronic warfare or defense capabilities and avionic electronics controlling flight operation of the autogyro;
the module receiving the AC current and the optical signals from the tether, said module having a power converter converting the AC current to DC current and supplying the DC current to the payload and avionic electronics, and a signal converter converting the optical signals into electrical signals and transmitting said signals to the payload and avionic electronics.

26. An airborne platform according to claim 25, wherein the electronics are supported in two generally cylindrical modules and the frame includes laterally spaced side panels supporting the modules therebetween;
one of the modules being supported above the other of said modules.

27. An airborne platform according to claim 25, wherein the module has openings therein permitting passage of air through the module such that the electronics therein are cooled.

28. An airborne platform according to claim 27, wherein the module has closures that close the openings and render the module watertight responsive to a detection of contact with water or a non-normal landing.

29. An airborne platform according to claim 26, wherein the autogyro further comprises a mast supporting the rotor, and said mast, said control surfaces, said modules and the side panels of the frame are of carbon fiber material.

30. A system linking a ground vehicle with an airborne platform, said system comprising:
a tether having
a mechanical portion providing sufficient tensional strength for retaining the airborne platform connected by the tether to the ground vehicle;
a metallic electrical conductor extending from a first end of the tether to an opposing second end of the tether, said conductor being configured to transmit AC current having a voltage of at least 400 volts and a power level of at least 600 watts;
at least one optical fiber extending from the first end to the second end of the tether;
first and second converters at the first and second ends of the tether, respectively;
each of said converters comprising
an electrical connection receiving incoming electrical signals,
an electrical-to-optical conversion unit connected with the electrical connection and converting said incoming electrical signals to outgoing optical signals and transmitting the outgoing optical signals over the optical fiber, and
an optical-to-electrical conversion unit receiving incoming optical signals transmitted through the optical fiber and converting said incoming optical signals to outgoing electrical signals and transmitting the outgoing electrical signals to the electrical connection.

31. The system of claim 30, wherein the system further comprises a power supply at one end of the tether with a step-up transformer supplying the AC current at a voltage in a range of 480 and 2000 volts and at a power level of 700 to 2000 watts, and a power processor at the other end of the tether receiving the AC current from the metal conductor and converting the AC current to DC current.

32. The system of claim 30, wherein the tether has at least one additional conductor carrying a different phase of the AC current.

33. The system of claim 30, wherein the tether has at least one further optical fiber, and wherein the incoming electrical signals comprise a plurality of electrical data signals, the electrical-to-optical conversion unit converting said electrical data signals into outgoing optical data signals each transmitted on a respective one of the optical fibers.

34. The system of claim 30, wherein the tether has at least one further optical fiber, and wherein the incoming electrical signals comprise a plurality of electrical data signals, the converter unit converting said electrical data signals into outgoing optical data signals, two of said optical data signals being transmitted together on one of the optical fibers.

35. The system of claim 34, wherein said optical data signals are time or frequency multiplexed.

36. The system of claim 34, wherein the conversion units are configured to provide multiplexing and demultiplexing of electrical signals including at least one of the group consisting of radio frequency (RF) signals, analog and digital video signals, Ethernet data signals, and discrete voltage signals, including Transistor-Transistor Logic (TTL).

37. The system of claim 30, wherein the system further comprises a grounded connection and the tether has a lightning rod conductor extending therealong configured to carry electrical energy of a lightning strike along the tether to said grounded connection.

38. The method according to claim 13, and further comprising selectively reeling in or reeling out the tether using a winch on the vehicle, and
wherein a movable platform is carried on the vessel, said movable platform supporting the airborne platform thereon before launch and after recovery, said movable platform being selectively moved to a first elevated height and;
during launch, supporting the airborne platform on a movable platform on the vessel, elevating the movable platform to a first elevated height, and reeling the tether out with the winch; and
during recovery of the airborne platform, lowering the movable platform to a second height lower than the first elevated height, and reeling the tether in with the winch.
